(19) United States
(12) Patent Application Publication
(10) Pub. No.: US 2023/0217218 A1
(43) Pub. Date: Jul. 6, 2023

(54) LAND MOBILE RADIO AND PUSH-TO-TALK-OVER-CELLULAR USER INTERFACE INTEROPERABILITY

(71) Applicant: BK Technologies Inc., West Melbourne, FL (US)

(72) Inventors: Lorenzo Cruger, JR., Boynton Beach, FL (US); John Marvin Suzuki, Rockville, MD (US)

(73) Assignee: BK Technologies Inc., West Melbourne, FL (US)

(21) Appl. No.: 17/902,097

(22) Filed: Sep. 2, 2022

Related U.S. Application Data
(60) Provisional application No. 63/296,562, filed on Jan. 5, 2022.

(51) Int. Cl. H04W 4/10

(52) U.S. Cl. CPC H04W 4/10; H04W 92/18

(57) ABSTRACT

A land mobile radio (LMR) device may be used with a cellular device in communication with a push-to-talk-over-cellular (POC) network. The LMR device may include an LMR processor, an LMR memory, an LMR local communication interface configured to communicate with the cellular device, and a channel selection input. The LMR processor may be configured to retrieve channel configuration information defining one or more POC channels from the cellular device via the LMR local communication interface and store the channel configuration information in the LMR memory. The channel selection input may be configured to select a selected channel from the one or more POC channels defined by the channel configuration information. The LMR local communication interface may be configured to communicate with the POC network over the selected channel via the cellular device.

### CROSS-REFERENCE TO RELATED APPLICATIONS

This application claims priority to U.S. Provisional Application No. 63/296,562, filed Jan. 5, 2022, the entire contents of which are incorporated herein by reference.

### BACKGROUND

Land mobile radios (LMRs) have been frequently used for fast and reliable one-talker to many-listener communication, especially in the context of government or public safety agencies. With the spread of cellular phone ownership over the past years, there has been a corresponding rise in push-to-talk-over-cellular (POC) services that have attempted to supplement or replace conventional LMR systems.

However, the audio hardware (speakers, microphones) in a cellular phone are often inferior to what is found in an LMR. Additionally, cellular phones often have inferior controls; for example, some are limited to touch screen controls for a software application. Accordingly, it may be desirable to develop systems and methods for allowing a user to use LMR audio hardware and controls to communicate over a POC network via a cellular phone.

Further, there may be situations where it is undesirable to use an LMR, such as on covert or undercover operations. Accordingly, it may be desirable to develop systems and methods for allowing a user to use a cellular phone to communicate over an LMR network, in order to maintain communication while avoiding the use of an obvious LMR.

### BRIEF SUMMARY

An exemplary embodiment of a land mobile radio (LMR) device may be used with a cellular device in communication with a push-to-talk-over-cellular (POC) network. The LMR device may include an LMR processor, an LMR memory, an LMR local communication interface configured to communicate with the cellular device, and a channel selection input. The LMR processor may be configured to retrieve channel configuration information defining one or more POC channels from the cellular device via the LMR local communication interface and store the channel configuration information in the LMR memory. The channel selection input may be configured to select a selected channel from the one or more POC channels defined by the channel configuration information. The LMR local communication interface may be configured to communicate with the POC network over the selected channel via the cellular device.

An exemplary embodiment of a cellular device may be used with a land mobile radio (LMR) device in communication with an LMR network. The cellular device may include a cellular processor, a cellular memory, a cellular local communication interface configured to communicate with the LMR device, and a cellular display. The cellular processor may be configured to retrieve channel configuration information defining one or more LMR channels from the LMR device via the cellular local communication interface and store the channel configuration information in the cellular memory. The cellular memory may store computer-executable instructions that, when executed by the cellular processor, cause the display to display a push-to-talk (PTT) user interface. The PTT user interface may include a channel control configured to select a selected channel from the one or more LMR channels defined by the channel configuration information. The cellular local communication interface may be configured to communicate with the LMR network over the selected channel via the LMR device.

A exemplary embodiment of a method of communicating on a push-to-talk-over-cellular (POC) network may include providing an LMR device, providing a cellular device, establishing communication between the LMR device and the cellular device, retrieving channel configuration information defining one or more POC channels from the cellular device and storing the channel configuration in the LMR device, selecting a selected channel on the LMR device from the one or more POC channels defined by the channel configuration information, communicating the selected channel to the cellular device; and communicating with the POC network over the selected channel with the LMR radio via the cellular device.

An exemplary embodiment of a method of communicating on a land mobile radio (LMR) network may include providing an LMR device, providing a cellular device, establishing communication between the LMR device and the cellular device, retrieving channel configuration information defining one or more LMR channels from the LMR device and storing the channel configuration in the cellular device, selecting a selected channel on the cellular device from the one or more LMR channels defined by the channel configuration information, communicating the selected channel to the LMR device; and communicating with the LMR network over the selected channel with the cellular device via the LMR radio.

### BRIEF DESCRIPTION OF THE SEVERAL VIEWS OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1 is a schematic drawing of an LMR device according to an exemplary embodiment;

FIG. 2 is a schematic block diagram of an LMR device according to an exemplary embodiment;

FIG. 3 is a schematic drawing of a cellular device according to an exemplary embodiment;

FIG. 4 is a schematic block diagram of a cellular device according to an exemplary embodiment;

FIG. 5 is a schematic diagram of operation of an LMR device and a cellular device according to an exemplary embodiment;

FIG. 6 is a schematic diagram of operation of an LMR device and a cellular device according to an exemplary embodiment;

FIG. 7 is a flowchart diagram of a method according to an exemplary embodiment; and

FIG. 8 is a flowchart diagram of a method according to an exemplary embodiment.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to aid in understanding the features of the exemplary embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

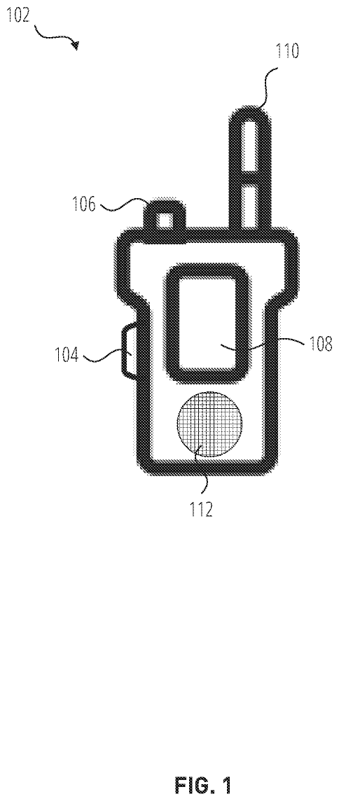

FIG. 1 shows a schematic drawing of an exemplary embodiment of a land mobile radio (LMR) device 102. The LMR device 102 shown in FIG. 1 is illustrated as a handheld LMR device, but it will be understood that the present disclosure is not limited to this embodiment. For example, in an alternative embodiment, the LMR device may be a vehicle-mounted LMR device or a stationary LMR device.

As seen in FIG. 1, the LMR device 102 may include a push-to-talk (PTT) input 104, a channel selection input 106, an LMR display 108, an LMR antenna 110, and an LMR audio device 112. The PTT input 104 may be a button, switch, touch input, or other suitable input device configured to activate the LMR device 102 for transmission of a message. The channel selection input 106 may be configured as a turnable knob or dial, slidable switch, button(s), or other suitable input device configured for selecting an LMR channel. The LMR display 108 may be a display screen for displaying various information to the user, such as, but not limited to, active channel, remaining battery life, configuration settings, signal strength, or the like. The LMR antenna 110 may be an antenna for communicating with an LMR network. In an exemplary embodiment, the LMR antenna 110 may also include components for communicating locally over a short range, including, but not limited to Bluetooth components, near field communication (NFC) components, and/or wireless LAN components. The LMR antenna 110 is depicted as being integrated with the body of the LMR device 102, but it will be understood that the disclosure is not limited to this embodiment. In an exemplary embodiment, the LMR antenna 110 may be provided as part of a tethered device, such as a remote speaker-microphone (RSM) or public safety mic (PSM).

The LMR audio device 112 may be configured for converting sound waves into audio signals and/or converting audio signals into sound waves. In an exemplary embodiment, the LMR audio device 112 may be a combined speaker/microphone. Alternatively, the LMR device 102 may include an LMR speaker and an LMR microphone as distinct components. In another exemplary embodiment, the LMR audio device 112 may be configured as a remote speaker-microphone (RSM). In an exemplary LMR/RSM configuration, the LMR device 102 may be worn on a user's belt or pocket, for example, and the RSM may be worn or attached on the user's shoulder. This configuration provides the microphone and speaker close to the user's ear to facilitate clear communication, while leaving the user's hands free for other tasks. In alternative exemplary embodiments, the LMR audio device 112 may include or be part of additional accessories, such as surveillance accessories, headsets, earpiece-only configurations, etc.

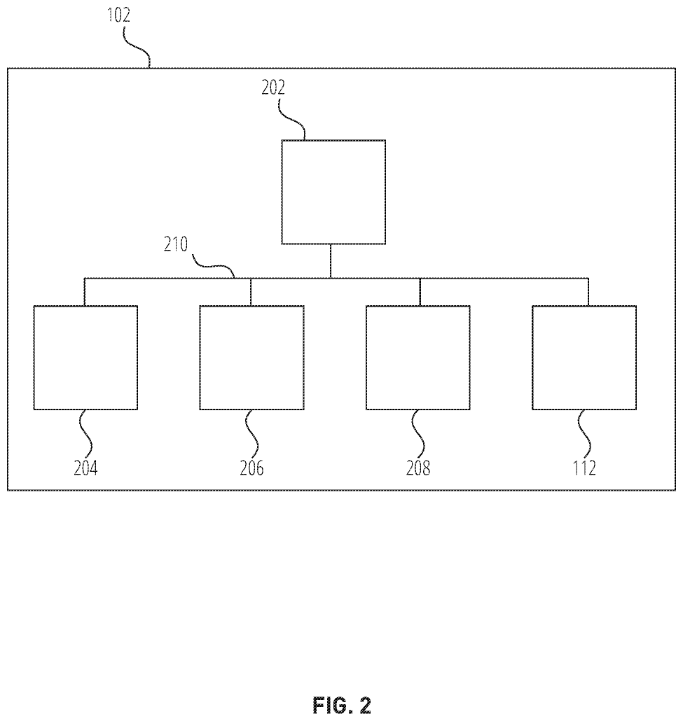

FIG. 2 is a schematic block diagram illustrating various exemplary components of an LMR device 102. For example, the LMR device 102 may include an LMR processor 202, an LMR memory 204, an LMR local communication interface 206, an LMR network antenna 208, and the LMR audio device 112, each of which may be mutually operably connected to each other, for example via an LMR bus 210. The LMR local communication interface 206 is intended to represent the components for local short range communication, such as the Bluetooth, NFC, and/or wireless LAN components described above. On the other hand, the LMR network antenna 208 is intended to represent the components required for long range LMR communication via the LMR network.

It will be understood that FIG. 2 is not intended to demonstrate a specific physical arrangement of the hardware of the LMR device 102, but is instead intended as a conceptual representation to show what structures may be present in the LMR device 102. It will be further understood that the LMR device 102 is not limited to the specifically illustrated connections between the parts. For example, in exemplary embodiments, certain components may be operably coupled to the LMR processor 202 without direct connection to other components.

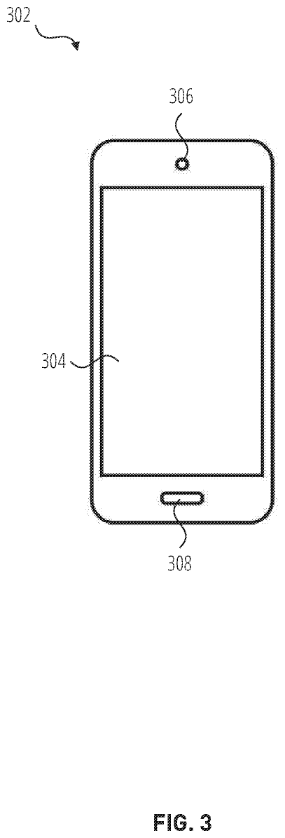

FIG. 3 is a schematic drawing of a cellular device 302. In the embodiment of FIG. 3, the cellular device 302 is illustrated as a smartphone, but it will be understood that disclosure is not limited to this embodiment. Rather, the cellular device 302 may be any device that is enabled for communication via broadband cellular networks, including, but not limited to, 3G networks, 4G networks, LTE networks, 5G networks, and the like. In alternative exemplary embodiments, the cellular device 302 may be a tablet, laptop computer, or other similar device configured to connect to a broadband cellular network. In an exemplary embodiment, the cellular device 302 may include a cellular display 304, a cellular speaker 306, and a cellular microphone 308. The cellular display 304 may be a touch-enabled display for allowing control and input via a user's touch. The cellular speaker 306 may be configured to produce sound waves based on audio signals, and the cellular microphone 308 may be configured to convert sound waves into audio signals. In an alternative exemplary embodiment, the cellular speaker 306 and the cellular microphone 308 may be configured as a combined speaker/microphone.

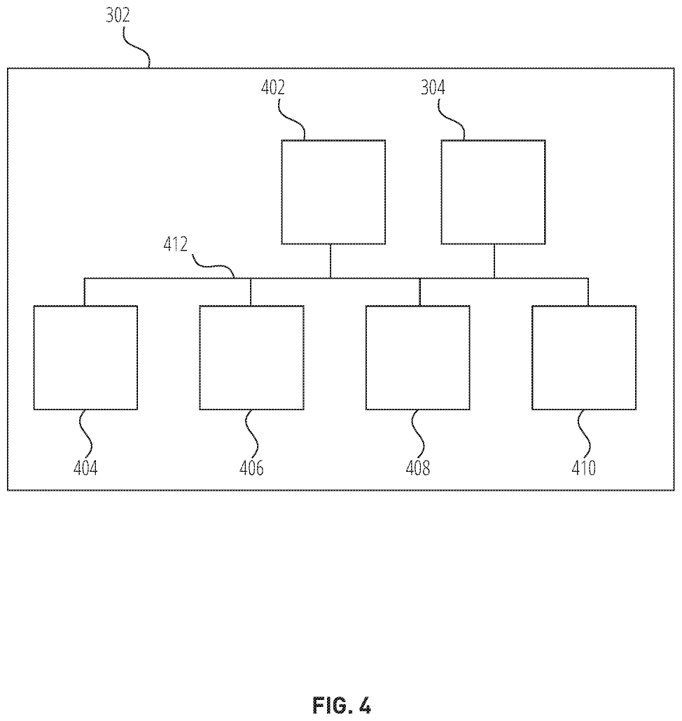

FIG. 4 is a schematic block diagram illustrating various exemplary components of a cellular device 302. For example, the cellular device 302 may include a cellular processor 402, a cellular memory 404, a cellular local communication interface 406, a cellular network antenna 408, a cellular audio device 410, and the cellular display 304, each of which may be mutually operably coupled via a cellular bus 412. The cellular local communication interface 406 is intended to represent the components for local short range communication, such as the Bluetooth, NFC, and/or wireless LAN components. On the other hand, the cellular network antenna 408 is intended to represent the components required for long range cellular communication via the broadband cellular network. The cellular audio device 410 is configured for conversion between sound waves and audio signals, and is represented in FIG. 3 by the cellular speaker 306 and the cellular microphone 308.

The cellular memory 404 may be a non-transitory memory that stores computer-executable instructions. The computer-executable instructions, when executed by the cellular processor 402, may cause the cellular display 304 to display a PTT user interface. The PTT user interface may include a cellular channel control configured to select a channel for communication over a push-to-talk-over-cellular (POC) network. In an exemplary embodiment, the cellular channel control may be represented as a dial, slide icon, or buttons to be manipulated by touch on the cellular display 304, but it will be understood that the disclosure is not limited to these embodiments. The PTT user interface may further include a cellular PTT input configured to mimic the function of the PTT input 104, i.e., a user may actuate the cellular PTT input when intending to transmit a message.

It will be understood that FIG. 4 is not intended to demonstrate a specific physical arrangement of the hardware of the cellular device 302, but is instead intended as a conceptual representation to show what structures may be present in the cellular device 302. It will be further understood that the cellular device 302 is not limited to the specifically illustrated connections between the parts. For example, in exemplary embodiments, certain components may be operably coupled to the cellular processor 402 without direct connection to other components.

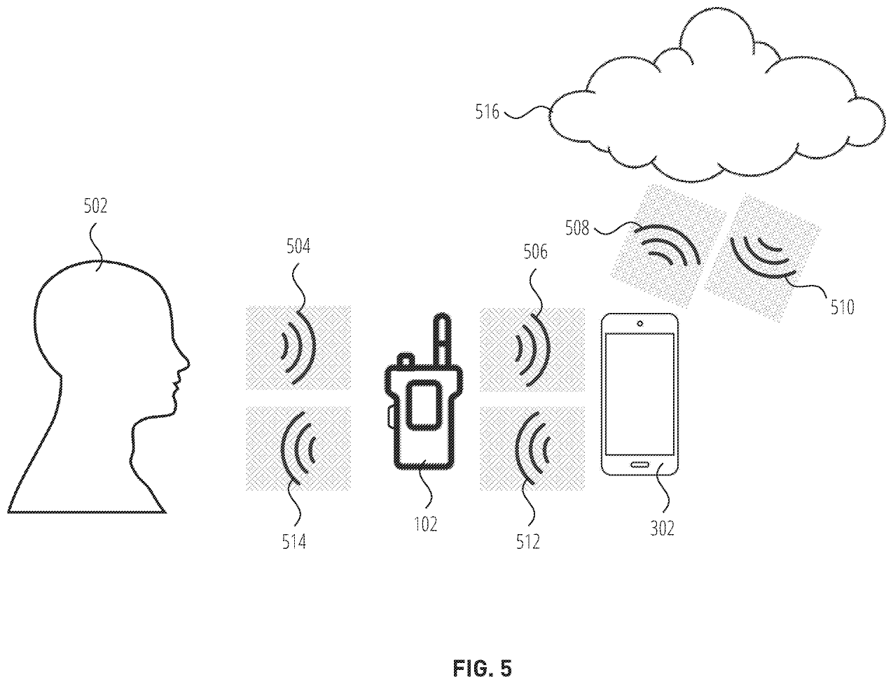

FIG. 5 is a schematic diagram illustrating an exemplary embodiment of operation of the LMR device 102 and the cellular device 302. The description below may also refer to structures illustrated in FIG. 1, FIG. 2, FIG. 3, and FIG. 4 as described above. In an exemplary embodiment, the LMR local communication interface 206 of the LMR device 102 may be configured to communicate with a POC network 516 via the cellular device 302.

In an exemplary embodiment, communication may be established between the LMR local communication interface 206 (FIG. 2) of the LMR device 102 and the cellular local communication interface 406 of the cellular device 302. This communication may be Bluetooth communication, NFC communication, wireless LAN communication, or other suitable local communication protocol. The cellular device 302 may be connected to a POC network 516, for example via the cellular network antenna 408 shown in FIG. 4. The POC network 516 may be the cellular broadband network used by the cellular device 302, or may be a separate network, and may be used for providing push-to-talk communication capability on cellular devices.

In an exemplary embodiment, the LMR local communication interface 206 may communicate with the cellular local communication interface 406 in order to retrieve channel configuration information from the cellular device 302. The channel configuration information may define one or more POC channels for communicating via the POC network 516. The channel configuration information may then be stored in the LMR memory 204 of the LMR device 102. Once the LMR device 102 has retrieved the channel configuration information, the channel selection input 106 of the LMR device 102 may be used to select a channel (i.e., the selected channel) from among the one or more POC channels defined by the channel configuration information. The selected channel may be communicated from the LMR device 102 to the cellular device 302 via the LMR local communication interface 206 and the cellular local communication interface 406.

Referring again to FIG. 5, the LMR device 102 may receive a first sound wave 504, such as words spoken by a user 502. The first sound wave 504 may be received by the LMR audio device 112 shown in FIG. 1, for example. In an exemplary embodiment, the user 502 may actuate the PTT input 104 of the LMR device 102 in order to put the LMR device 102 into a mode to receive the sound wave 504. The LMR device 102 may include components and/or software to convert the first sound wave 504 into a first audio signal 506. The LMR local communication interface 206 may transmit the first audio signal 506 to the cellular local communication interface 406.

The cellular device 302 may in turn convert the first audio signal 506 into a second audio signal 508 (for example, the first audio signal 506 and the second audio signal 508 may differ in frequency, modulation, encoding, or other type of signal parameter). The cellular device 302 may then transmit the second audio signal 508 to the POC network 516, along with an indication of the selected channel. The second audio signal 508 may then be received by other devices connected to the POC network 516 and tuned to the selected channel. In this way, the user 502 may use the controls of the LMR device 102 to select a channel and speak while leveraging the connection between the LMR device 102 and the cellular device 302 to transmit the message to the POC network 516 over the selected channel via the cellular network antenna 408 of the cellular device 302.

In another exemplary embodiment, the cellular device 302 may receive a third audio signal 510 from the POC network 516 over the selected channel. The third audio signal 510 may correspond to a message transmitted from another user connected to the POC network 516. After receiving the third audio signal 510, the cellular device 302 may convert the third audio signal 510 into a fourth audio signal 512 suitable for transmission between the cellular local communication interface 406 of the cellular device 302 and the LMR local communication interface 206 of the LMR device 102. The cellular device 302 may then transmit the fourth audio signal 512 to the LMR device 102. The LMR device 102 may in turn receive the fourth audio signal 512 and convert the fourth audio signal 512 into a second sound wave 514 to be played by the LMR audio device 112 of the LMR device 102. In this way, the user 502 may leverage the connection between the LMR device 102 and the cellular device 302 to receive the message from the POC network 516 over the selected channel via the cellular network antenna 408, yet play the message over the LMR audio device 112 of the LMR device 102.

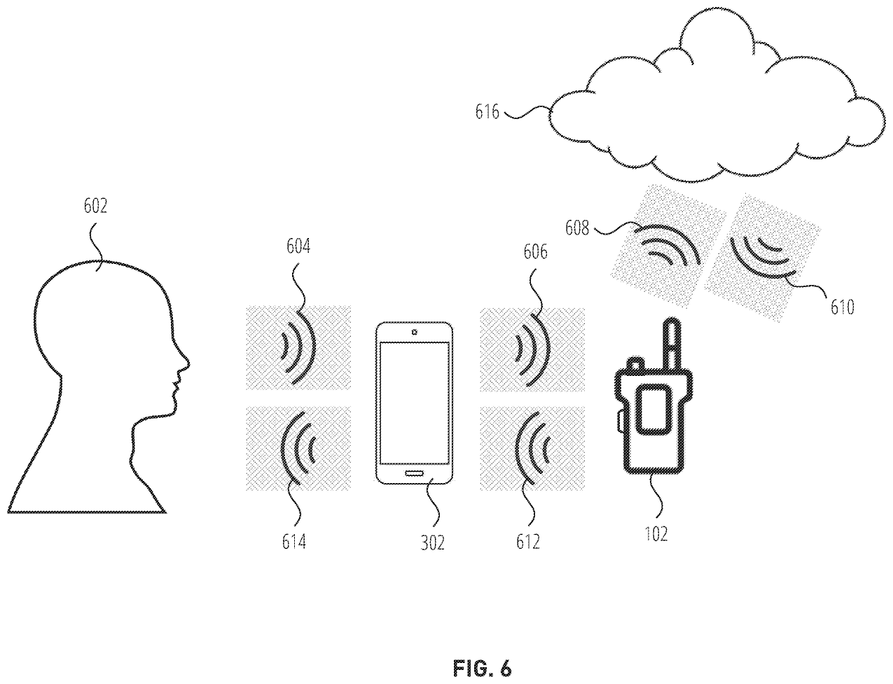

FIG. 6 is a schematic diagram illustrating an exemplary embodiment of operation of the LMR device 102 and the cellular device 302. The description below may also refer to structures illustrated in FIG. 1, FIG. 2, FIG. 3, and FIG. 4 as described above. In an exemplary embodiment, the cellular local communication interface 406 of the cellular device 302 may be configured to communicate with an LMR network 616 via the LMR device 102.

In an exemplary embodiment, communication may be established between the cellular local communication interface 406 of the cellular device 302 and the LMR local communication interface 206 of the LMR device 102. This communication may be Bluetooth communication, NFC communication, wireless LAN communication, or other suitable local communication protocol. The LMR device 102 may be connected to an LMR network 616, for example via the LMR network antenna 208 shown in FIG. 2. The LMR network 616 may be a network for providing LMR communication capability between multiple devices.

In an exemplary embodiment, the cellular local communication interface 406 of the cellular device 302 may communicate with the LMR local communication interface 206 in order to retrieve channel configuration information from the LMR device 102. The channel configuration information may define one or more LMR channels for communicating via the LMR network 616. The channel configuration information may then be stored in the cellular memory 404 of the cellular device 302. Once the cellular device 302 has retrieved the channel configuration information, the cellular channel control displayed on the cellular display 304 of the cellular device 302 may be used to select a selected channel from among the one or more LMR channels defined by the channel configuration information. The selected channel may be communicated from the cellular device 302 to the LMR device 102 via the cellular local communication interface 406 and the LMR local communication interface 206.

Referring again to FIG. 6, the cellular device 302 may receive a first sound wave 604, such as words spoken by a user 602. The first sound wave 604 may be received by the cellular microphone 308 shown in FIG. 3, for example. In an exemplary embodiment, the user 602 may actuate the cellular PTT input displayed on the cellular display 304 in order to put the cellular device 302 into a mode to receive the first sound wave 604. The cellular device 302 may include components and/or software to convert the first sound wave 604 into a first audio signal 606. The cellular local communication interface 406 may transmit the first audio signal 606 to the LMR local communication interface 206.

The LMR device 102 may in turn convert the first audio signal 606 into a second audio signal 608 (for example, the first audio signal 606 and the second audio signal 608 may differ in frequency, modulation, encoding, or other type of signal parameter). The LMR device 102 may then transmit the second audio signal 608 to the LMR network 616 over the selected channel. The second audio signal 608 may then be received by other devices connected to the LMR network 616 and tuned to the selected channel. In this way, the user 602 may use the PTT user interface of the cellular device 302 to select a channel and speak while leveraging the connection between the cellular device 302 and the LMR device 102 to transmit the message to the LMR network 616 over the selected channel via the LMR network antenna 208 of the LMR device 102.

In another exemplary embodiment, the LMR device 102 may receive a third audio signal 610 from the LMR network 616 over the selected channel. The third audio signal 610 may correspond to a message transmitted from another user connected to the LMR network 616. After receiving the third audio signal 610, the LMR device 102 may convert the third audio signal 610 into a fourth audio signal 612 suitable for transmission between the LMR local communication interface 206 of the LMR device 102 and the cellular local communication interface 406 of the cellular device 302. The LMR device 102 may then transmit the fourth audio signal 612 to the cellular device 302. The cellular device 302 may in turn receive the fourth audio signal 612 and convert the fourth audio signal 612 into a second sound wave 614 to be played by the cellular speaker 306. In this way, the user 602 may leverage the connection between the cellular device 302 and the LMR device 102 to receive the message from the LMR network 616 over the selected channel via the LMR network antenna 208, yet play the message over the cellular speaker 306 of the cellular device 302.

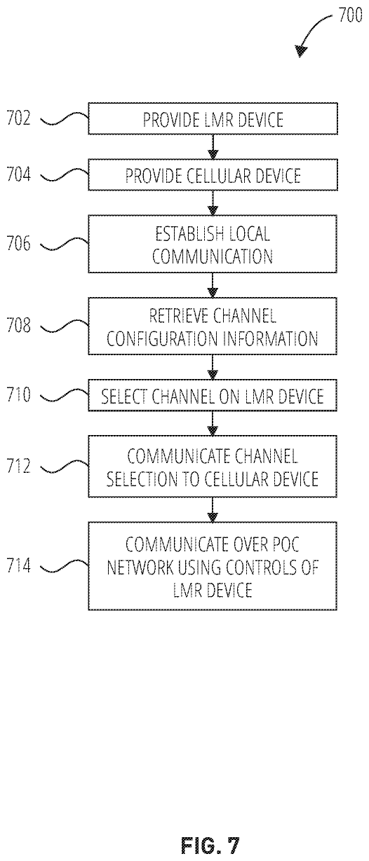

FIG. 7 is a flowchart diagram illustrating an exemplary embodiment of a method 700 for communicating on a POC network. In block 702, an LMR device is provided. The LMR device may be the LMR device 102 as described above, for example. In an exemplary embodiment, the LMR device may be a handheld LMR device, but the disclosure is not limited to this embodiment. In block 704, a cellular device is provided. The cellular device may be the cellular device 302 as described above. In an exemplary embodiment, the cellular device may be a smartphone, but the disclosure is not limited to this embodiment.

In block 706, local communication is established between the LMR device 102 and the cellular device 302. In an exemplary embodiment, this local communication may be established between the LMR local communication interface 206 of the LMR device 102 and the cellular local communication interface 406 of the cellular device 302, and may be Bluetooth communication, NFC, wireless LAN communication, or other suitable communication protocol.

In block 708, the LMR device 102 may retrieve channel configuration information from the cellular device 302. The channel configuration information may define one or more POC channels for communicating on the POC network. After retrieval, the configuration information may be stored locally in the LMR device 102, for example in the LMR memory 204. In an alternative exemplary embodiment, the channel configuration information may be pre-loaded into the LMR device 102, and retrieval of the channel configuration information may not be necessary.

In block 710, one of the POC channels defined in the channel configuration information is selected as a selected channel. The selected channel may be selected by using the channel selection input 106 on the LMR device 102. Following selection of the channel, the selected channel may be communicated from the LMR device 102 to the cellular device 302 in block 712.

In block 714, the user may communicate via the POC network over the selected channel by using the controls of the LMR device 102. For example, the user may actuate the PTT input 104 and speak to transmit a message. The LMR device 102 may receive the sound wave of the user's voice and convert the sound wave into a first audio signal. The first audio signal may be relayed through the cellular device 302 to the POC network over the selected channel (alternatively, the cellular device 302 may convert the first audio signal into a second audio signal before transmitting to the POC network), where it may be received by other users tuned to the same channel. Alternatively, in block 714, the cellular device 302 may receive a third audio signal from the POC network over the selected channel. The cellular device 302 may communicate the received audio signal to the LMR device 102 (alternatively, the cellular device 302 may convert the third audio signal into a fourth audio signal before transmitting the LMR device 102), where it may be converted into a sound wave for the user to hear.

The method 700 may provide advantages to the user in that it allows the user to access a POC network via the cellular device 302, which may be more common or easier to access, but still allows the user to take advantage of the superior microphone and speaker that may be found on the LMR device 102. For example, an LMR device or RSM coupled to an LMR device will often have more powerful speakers and more sensitive (and/or noise cancelling) microphones than those found in a typical cellular device. Additionally, the user may use the signal selection and PTT controls of the LMR device 102, which may be easier to manipulate and more intuitive than the controls on a PTT user interface found on the cellular device 302. Additionally, the method 700 may allow the user to control communications through both the LMR network and the cellular network via the same controls and user interface.

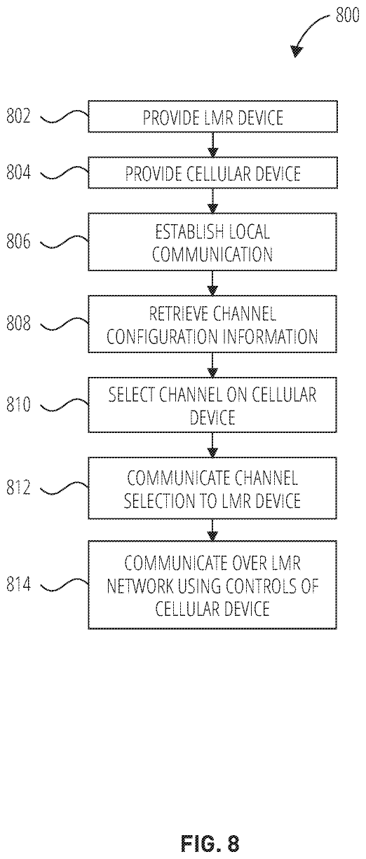

FIG. 8 is a flowchart diagram illustrating an exemplary embodiment of a method 800 for communicating on an LMR network. In block 802, an LMR device is provided. The LMR device may be the LMR device 102 as described above, for example. In an exemplary embodiment, the LMR device may be a handheld LMR device, but the disclosure is not limited to this embodiment. In block 804, a cellular device is provided. In an exemplary embodiment, the cellular device may be a smartphone similar to the cellular device 302, but the disclosure is not limited to this embodiment.

In block 806, local communication is established between the LMR device 102 and the cellular device 302. In an exemplary embodiment, this local communication may be established between the LMR local communication interface 206 of the LMR device 102 and the cellular local communication interface 406 of the cellular device 302, and may be Bluetooth communication, NFC, wireless LAN communication, or other suitable communication protocol.

In block 808, the cellular device 302 may retrieve channel configuration information from the LMR device 102. The channel configuration information may define one or more LMR channels for communicating on the LMR network. After retrieval, the configuration information may be stored locally in the cellular device 302, for example in the cellular memory 404. In an alternative exemplary embodiment, the channel configuration information may be pre-loaded into the LMR device 102, and retrieval of the channel configuration information may not be necessary.

In block 810, one of the LMR channels defined in the channel configuration information is selected as a selected channel. The selected channel may be selected by using the cellular channel controls displayed on the cellular display 304 of the cellular device 302, for example. Following selection of the channel, the selected channel may be communicated from the cellular device 302 to the LMR device 102 in block 812.

In block 814, the user may communicate via the LMR network over the selected channel by using the controls of the cellular device 302. For example, the user may actuate a cellular PTT input of the POC PTT user interface displayed on the cellular display 304 and speak to transmit a message. The cellular device 302 may receive the sound wave of the user's voice and convert the sound wave into a first audio signal. The first audio signal may be relayed through the LMR device 102 to LMR network over the selected channel (alternatively, the LMR device 102 may convert the first audio signal into a second audio signal before transmitting to the LMR network), where it may be received by other users tuned to the same channel. Alternatively, in block 814, the LMR device 102 may receive a third audio signal from the LMR network over the selected channel. The LMR device 102 may communicate the third audio signal to the cellular device 302, where it may be converted into a sound wave for the user to hear.

The method 800 may provide advantages to the user in certain circumstances. For example, a law enforcement official on covert or undercover operations may need to avoid the obvious presence of an LMR. In this situation, the user could use a cellular device to communicate over the LMR network without revealing the LMR device. Additionally, the method 800 may allow the user to control communications through both the LMR network and the cellular network via the same controls and user interface.

The description above refers to POC channels and LMR channels. It will be understood that, for the context of this disclosure, a channel may use analog or digital waveforms. Further, the channels describe herein may be operating in conventional or trunked modes. The channel may be organized into groups known as zones, which may be organized based on agency (for example, law enforcement, fire, medical, military, etc.), geographically, or in some other organization scheme. In an exemplary embodiment, in a given zone, there may be a dispatch channel, an information channel, a tactical channel, a mutual-aid channel, etc. In an exemplary embodiment, when the LMR device 102 and the cellular device 302 described above are paired in communication with each other, the LMR device 102 may be configured to operate in a zone dedicated to POC communications, which may be populated with the POC channels of the cellular device 302 upon pairing.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while considering that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine”, “calculate” and “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

What is claimed is:

1. A land mobile radio (LMR) device for use with a cellular device in communication with a push-to-talk-over-cellular (POC) network, the LMR device comprising:
an LMR processor;
an LMR memory;
an LMR local communication interface configured to communicate with the cellular device; and
a channel selection input;
wherein the LMR processor is configured to retrieve channel configuration information defining one or more POC channels from the cellular device via the LMR local communication interface and store the channel configuration information in the LMR memory;
the channel selection input is configured to select a selected channel from the one or more POC channels defined by the channel configuration information;
the LMR local communication interface is configured to communicate with the POC network over the selected channel via the cellular device.

2. The LMR device of claim 1, wherein the LMR local communication interface is configured to transmit an audio signal to the POC network over the selected channel via the cellular device.

3. The LMR device of claim 1, wherein the LMR local communication interface is configured to receive an audio signal from the POC network over the selected channel via the cellular device.

4. The LMR device of claim 1, further comprising an LMR audio device configured to:
convert a first audio signal into a first sound wave; or
convert a second sound wave into a second audio signal.

5. The LMR device of claim 4, wherein:
the LMR audio device is an LMR combined speaker/microphone; and
the LMR combined speaker/microphone is configured to convert the first audio signal into the first sound wave and convert the second sound wave into the second audio signal.

6. The LMR device of claim 4, wherein the LMR audio device comprises:
an LMR speaker configured to convert the first audio signal into the first sound wave; and
an LMR microphone configured to convert the second sound wave into the second audio signal.

7. The LMR device of claim 4, further comprising a push-to-talk (PTT) input; wherein:
the LMR audio device is configured to receive the second sound wave and convert the second sound wave into the second audio signal in response to actuation of the PTT input; and
the LMR local communication interface is configured to transmit the second audio signal to the POC network over the selected channel via the cellular device in response to actuation of the PTT input.

8. A cellular device for use with a land mobile radio (LMR) device in communication with an LMR network, the cellular device comprising:
a cellular processor;
a cellular memory;
a cellular local communication interface configured to communicate with the LMR device; and
a cellular display;
wherein the cellular processor is configured to retrieve channel configuration information defining one or more LMR channels from the LMR device via the cellular local communication interface and store the channel configuration information in the cellular memory;
the cellular memory stores computer-executable instructions that, when executed by the cellular processor, cause the display to display a push-to-talk (PTT) user interface;
the PTT user interface comprises a channel control configured to select a selected channel from the one or more LMR channels defined by the channel configuration information;
the cellular local communication interface is configured to communicate with the LMR network over the selected channel via the LMR device.

9. The cellular device of claim 8, wherein the cellular local communication interface is configured to receive an audio signal from the LMR network over the selected channel via the LMR device.

10. The cellular device of claim 8, wherein the cellular local communication interface is configured to transmit an audio signal to the LMR network over the selected channel via the LMR device.

11. The cellular device of claim 9, further comprising a cellular audio device configured to:
convert a first audio signal into a first sound wave; or
convert a second sound wave into a second audio signal.

12. The cellular device of claim 11, wherein:
the cellular audio device is a cellular combined speaker/microphone; and
the cellular combined speaker/microphone is configured to convert the first audio signal into the first sound wave and convert the second sound wave into the second audio signal.

13. The cellular device of claim 11, wherein the cellular audio device comprises:
a cellular speaker configured to convert the first audio signal into the first sound wave; and
a cellular microphone configured to convert the second sound wave into the second audio signal.

14. The cellular device of claim 11, wherein:
the PTT user interface further comprises a cellular PTT input;
the cellular audio device is configured to receive the second sound wave and convert the second sound wave into the second audio signal in response to actuation of the cellular PTT input; and
the cellular local communication interface is configured to transmit the second audio signal to the LMR network over the selected channel via the cellular local communication interface in response to actuation of the cellular PTT input.

15. A method of communicating on a push-to-talk-over-cellular (POC) network, the method comprising:
providing an LMR device;
providing a cellular device;
establishing communication between the LMR device and the cellular device;
retrieving channel configuration information defining one or more POC channels from the cellular device and storing the channel configuration in the LMR device;
selecting a selected channel on the LMR device from the one or more POC channels defined by the channel configuration information;
communicating the selected channel to the cellular device; and
communicating with the POC network over the selected channel with the LMR radio via the cellular device.

16. The method of claim 15, wherein the communicating over the POC network further comprises:
receiving a first audio signal from the POC network over the selected channel with the cellular device;
communicating the first audio signal from the cellular device to the LMR device;
converting the first audio signal into a first sound wave with the LMR device; and
playing the first sound wave with the LMR device.

17. The method of claim 15, wherein the communicating over the POC network further comprises:
receiving a first sound wave with the LMR device;
converting the first sound wave into a first audio signal with the LMR device;
communicating the first audio signal from the LMR device to the cellular device; and
transmitting the first audio signal to the POC network over the selected channel with the cellular device.

18. A method of communicating on a land mobile radio (LMR) network, the method comprising:
providing an LMR device;
providing a cellular device;
establishing communication between the LMR device and the cellular device;
retrieving channel configuration information defining one or more LMR channels from the LMR device and storing the channel configuration in the cellular device;
selecting a selected channel on the cellular device from the one or more LMR channels defined by the channel configuration information;
communicating the selected channel to the LMR device; and
communicating with the LMR network over the selected channel with the cellular device via the LMR radio.

19. The method of claim 18, wherein the communicating with the LMR network further comprises:
receiving a first audio signal from the LMR network over the selected channel with the LMR device;
communicating the first audio signal from the LMR device to the cellular device;
converting the first audio signal into a first sound wave with the cellular device; and
playing the first sound wave with the cellular device.

20. The method of claim 18, wherein the communicating with the LMR network further comprises:
receiving a first sound wave with the cellular device;
converting the first sound wave into a first audio signal with the cellular device;
communicating the first audio signal from the LMR device to the cellular device; and
transmitting the first audio signal to the LMR network over the selected channel with the LMR device.
